(19) United States
(12) Patent Application Publication
(10) Pub. No.: US 2017/0134985 A1
(43) Pub. Date: May 11, 2017

(54) MANAGING USER EQUIPMENT (UE) PERFORMANCE VIA SIMULTANEOUS USE OF MULTIPLE INTERFACES

(71) Applicant: QUALCOMM Incorporated, San Diego, CA (US)

(72) Inventors: Venkata Ramanan VENKATACHALAM JAYARAMAN, San Diego, CA (US); Prashanth MYSORE, San Diego, CA (US); Murtuza Taheri CHHATRIWALA, San Diego, CA (US); Vinod MENON, San Diego, CA (US)

(21) Appl. No.: 15/234,745

(22) Filed: Aug. 11, 2016

Related U.S. Application Data
(60) Provisional application No. 62/252,921, filed on Nov. 9, 2015.

(51) Int. Cl. H04W 28/08; H04W 76/02

(52) U.S. Cl. CPC H04W 28/085; H04W 76/025; H04W 84/12

(57) ABSTRACT

The present disclosure presents a method and an apparatus for managing performance of a user equipment (UE). For example, the disclosure presents a method for managing performance of a UE by computing, at a user equipment (UE), a first capacity estimate over a Wi-Fi interface in response to initiating of a new connection at the UE; detecting, at the UE, that the first capacity estimate is below an aggregation threshold; computing, at the UE, a second capacity estimate over a cellular interface in response to detecting that the first capacity estimate is below the aggregation threshold; and assigning the new connection initiated at the UE to the Wi-Fi interface or the cellular interface based at least on the first capacity estimate or the second capacity estimate. As such, performance of a UE may be managed.

### CLAIM OF PRIORITY

The present application for patent claims priority to U.S. Provisional Patent Application No. 62/252,921, filed Nov. 9, 2015, entitled “Managing User Equipment (UE) Performance via Simultaneous Use of Multiple Interfaces,” which is assigned to the assignee hereof, and hereby expressly incorporated by reference herein.

### BACKGROUND

The present disclosure relates generally to communication systems, and more particularly, to performance of a user equipment (UE).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-multiple-input multiple-output (MIMO) antenna technology. However, as the for mobile broadband access continues to increase, there exists a need for further improvements in LTE technology. Preferably, these improvements should be applicable to other multi-access technologies and the telecommunication standards employ these technologies.

A typical mode of operation at a user equipment (UE) is to use either a Wi-Fi communication interface or a cellular (e.g., CDMA, W-CDMA, LTE, etc.) communication interface to transfer packet data depending on Wi-Fi availability. However, when a data rate over the Wi-Fi interface is poor or low, for example, due to poor signal or capacity issues, the UE does not switch to the cellular interface as the UE is generally configured to switch to the cellular interface only when the Wi-Fi interface is unavailable. That is, the UE will not switch to the cellular interface unless the Wi-Fi interface is not available at all.

Thus, there is a desire for a method and an apparatus for managing performance at a UE when data rates over a Wi-Fi interface are low or poor.

### BRIEF DESCRIPTION OF THE DRAWINGS

FIG. 1 is a schematic diagram of a wireless communications system including a user equipment having an aspect of a UE performance management function for managing performance of the UE.

FIG. 2A-2B are block diagrams illustrating example aspects for managing performance of a user equipment, in accordance with aspects of the present disclosure.

FIG. 3 is a conceptual diagram illustrating an example for computing data rates at the UE, in accordance with aspects of the present disclosure.

FIG. 4 illustrating an example method for managing performance of a user equipment, in accordance with aspects of the present disclosure.

FIG. 5 is a block diagram conceptually illustrating an example of a telecommunications system, including aspects of the system of FIG. 1.

FIG. 6 is a conceptual diagram illustrating an example of an access network for use with a UE, in accordance with an aspect of the present disclosure.

FIG. 7 is a block diagram conceptually illustrating an example hardware implementation for an apparatus employing a processing system configured in accordance with an aspect of the present disclosure.

FIG. 8 is a conceptual diagram illustrating an example of a radio protocol architecture for the user and control planes for a base station and/or a UE, in accordance with an aspect of the present disclosure.

FIG. 9 is a block diagram conceptually illustrating examples of an eNodeB and a UE configured in accordance with an aspect of the present disclosure.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, a method for managing performance of a user equipment (UE) is provided. The method includes computing, at a user equipment (UE), a first capacity estimate over a Wi-Fi interface in response to initiating of a new connection at the UE; detecting, at the UE, that the first capacity estimate is below an aggregation threshold; computing, at the UE, a second capacity estimate over a cellular interface in response to detecting that the first capacity estimate is below the aggregation threshold; and assigning the new connection initiated at the UE to the Wi-Fi interface or the cellular interface based at least on the first capacity estimate or the second capacity estimate.

In another example, a user equipment (UE) for managing performance is provided. The user equipment includes a memory configured to store data and one or more processors communicatively coupled with the memory, wherein the one or more processors and the memory are configured to compute, at a user equipment (UE), a capacity estimate over a Wi-Fi interface in response to initiating of a new connection the UE; detect, at the UE, that the first capacity estimate is below an aggregation threshold; compute, at the UE, a second capacity estimate over a cellular interface in response to detecting that the first capacity estimate is below the aggregation and assign the new connection initiated at the UE to the Wi-Fi interface or the cellular interface based at least on the first capacity estimate or the second capacity estimate.

In a further example, a user equipment (UE) for managing performance is provided. The user equipment includes means for computing, at a user equipment (UE), a first capacity estimate over a Wi-Fi interface in response to initiating of a new connection at the UE; means for detecting, at the UE, that the first capacity estimate is below an aggregation threshold; means for computing, at the UE, a second capacity estimate over a cellular interface in response to detecting that the first capacity estimate is below the aggregation threshold; and means for assigning the new connection initiated at the UE to the Wi-Fi interface or the cellular interface based at least on the first capacity estimate or the second capacity estimate.

Additionally, in another example, a computer readable medium storing computer executable code for managing performance of a user equipment (UE) is provided. The computer readable medium includes code for computing, at a user equipment (UE), a first capacity estimate over a Wi-Fi interface in response to initiating of a new connection at the UE; code for detecting, at the UE, that the first capacity estimate is below an aggregation threshold; code for computing, at the UE, a second capacity estimate over a cellular interface in response to detecting that the first capacity estimate is below the aggregation threshold; and code for assigning the new connection initiated at the UE to the Wi-Fi interface or the cellular interface based at least on the first capacity estimate or the second capacity estimate.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

As used herein, a small cell or a small cell base station or access point may refer to, but is not limited to, a femtocell, picocell, microcell, or any other cell or base station having a relatively small transmit power or relatively small (e.g., on the order of meters or 10s of meters) coverage area (e.g., including one or more cells) as compared to a macro cell or macro base station (e.g., having a coverage area on the order of kilometers or tens of kilometers). The techniques described herein may be used for various wireless communication networks such as CDMA, TDMA, FDMA, OFDMA, SC-FDMA and other networks. The terms “network” and “system” are often used interchangeably.

A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-standards. A TDMA network may implement a radio technology such as Global System for Mobile Communications (GSM). An OFDMA network may implement a radio technology such as Evolved UTRA (E-UTRA), Ultra Mobile Broadband IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP LTE and LTE-Advanced (LTE-A) are new releases of UMTS that E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as wireless networks and radio technologies. For clarity, certain aspects of the are described below for LTE, and LTE terminology is used in much of the description below.

The present disclosure recites a method, an apparatus, and a computer readable medium for managing performance of a user equipment (UE). For example, the present disclosure manages the performance of a UE when the capacity estimate (e.g., first capacity estimate) over a Wi-Fi interface is low (that is, below a threshold). In an example aspect, a UE performance management function may detect that a capacity estimate over the Wi-Fi interface is below the threshold and computes a capacity estimate (e.g., second capacity estimate) over a cellular interface. The UE performance management functions assigns one or more new data connections at the UE to the cellular interface based on the threshold, first capacity estimate, and/or the second capacity estimate.

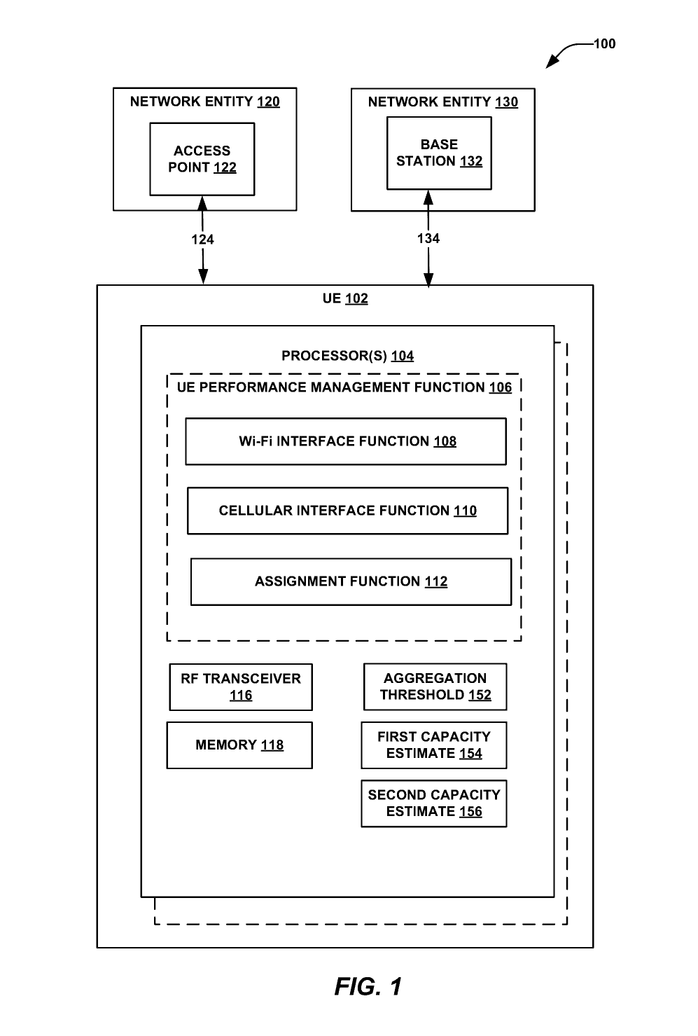

Referring to FIG. 1, in an aspect, a wireless communication system 100 includes a user equipment (UE), e.g., UE 102, in communication with one or more network entities 120 and/or 130. For instance, in an aspect, network entity 120 may include an access point (AP) 122 which may be a Wi-Fi AP; network entity 130 may include a base station (BS) 132 for supporting communications with the UE. For example, BS 132 may be a cellular BS operating on a radio access technology (RAT) standard according to 3rd Generation Partnership Project (3GPP). In an example aspect, base station 132 may operate according to Wideband Code Division Multiple Access (W-CDMA), Code Division Multiple Access (CDMA), Time Division Synchronous Code Division Multiple Access (TD-SCDMA), Long Term Evolution (LTE), or Global System for Mobile Communications (GSM) standard, etc. as defined in 3GPP Specifications. In an aspect, UE 102 may be in communication with AP 122 via a Wi-Fi interface 124 and/or UE 102 may be in communication with BS 132 via a cellular interface 134. Further, Wi-Fi interface 124 may include an uplink (UL) 126 and/or downlink (DL) 128; and/or cellular interface 134 may include an UL 136 and/or DL 138. In an additional aspect, network entity 130 may include a radio network controller (RNC) and/or mobile management entity (MME), not shown in FIG. 1.

UE 102 may download (or upload) data using (or to) network entity 120 over Wi-Fi interface 124 or using cellular interface 134. For example, when UE 102 executes an application such as a browser for loading a web page, the browser may typically open multiple transmission control protocol (TCP) sockets (e.g., tens of TCP sockets, depending on the web site) to simultaneously receive and/or transmit data. Each connection/socket may be used several times to obtain objects such as hypertext markup language (HTML), cascading style sheet (CSS), Javascript, and/or media images, videos, etc.).

In an aspect, the present disclosure describes a mechanism for reducing the amount of time it may take for an application (e.g., browsing application) running on UE 102 to load a webpage in conditions where throughput over Wi-Fi interface 124 (e.g., via DL 128) may be limited (e.g., low, poor, etc.). That is, a data rate, throughput, etc. over DL 128 of Wi-Fi interface 124 is not sufficient to provide robust user experience to the user (e.g., user of UE 102). The disclosure presents a mechanism where a reduction in loading time of a web page under poor data rate conditions over Wi-Fi interface 124 may be achieved by using a cellular interface 134 available at UE 102 as a supplement to Wi-Fi interface 124. That is, when the data rate over the Wi-Fi interface 124 is not good, DL 138 of cellular interface 134 may be used for loading the web page in conjunction (e.g., in addition) to DL 128 of Wi-Fi interface 124 For instance, the present disclosure describes a mechanism, procedure, and/or an apparatus which dynamically determines whether to assign newly created TCP connections or sockets to Wi-Fi interface 124 or cellular interface 134. For instance, when the data rate over Wi-Fi interface 124 is good (e.g., equal to or above a threshold, an “aggregation threshold,”) new connections are assigned to Wi-Fi interface 124 for data transfer (e.g., data reception and/or transmission). However, when the data rate over the Wi-Fi interface is poor (e.g., below the aggregation threshold), the new connections may be split between Wi-Fi interface 124 and/or cellular interface 134. Additionally, the “data rate” over an interface that is computed may also be considered as “estimated capacity” or “throughput” via the wireless interface with one or more UL/DL on each interface, and such UL/DL may also be referred to as communication links; that one or more connections may be assigned to each interface and/or each UL or DL and/or each communication link, etc.

Further, as the capacity estimates over Wi-Fi and cellular interfaces rapidly, the capacity estimates are monitored continuously, and the connections may assigned to Wi-Fi interface, cellular interface, or both, on an ongoing basis. This allows both the Wi-Fi and the cellular interfaces to be used together for receiving (and/or transmitting data). Additionally, the present aspects may include distributing the new connections over both the Wi-Fi interface 124 and the cellular interface 134 a particular manner (described below) based on estimated Wi-Fi capacity, estimated cellular capacity, and the aggregation threshold, which may provide sensitivity to cellular data usage.

Further, in an additional aspect, UE 102 and/or UE performance management function 106 may continuously (rather than periodically) monitor the capacity estimate on DL 128 (of Wi-Fi interface 124) and compare it with the aggregation threshold 152 to detect that the capacity estimate at UE 102 over Wi-Fi interface 124 is below the aggregation threshold 152. This provides for pro-active management of the UE performance rather than a reactive management. In a further additional aspect, UE 102 and/or UE performance management function 106 may chose the threshold based on the type of application (e.g., VoIP, streaming video, etc.) and/or whether an application is delay sensitive or not. That is, UE 102 and/or UE performance management function 106 may set or configure the threshold to a higher value for delay sensitive applications or to a lower value for applications that are not delay sensitive.

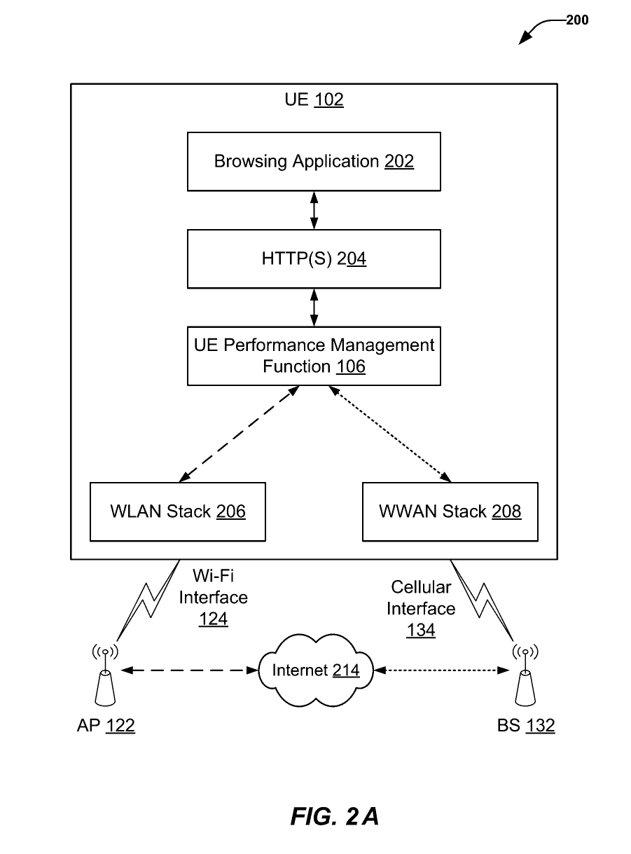

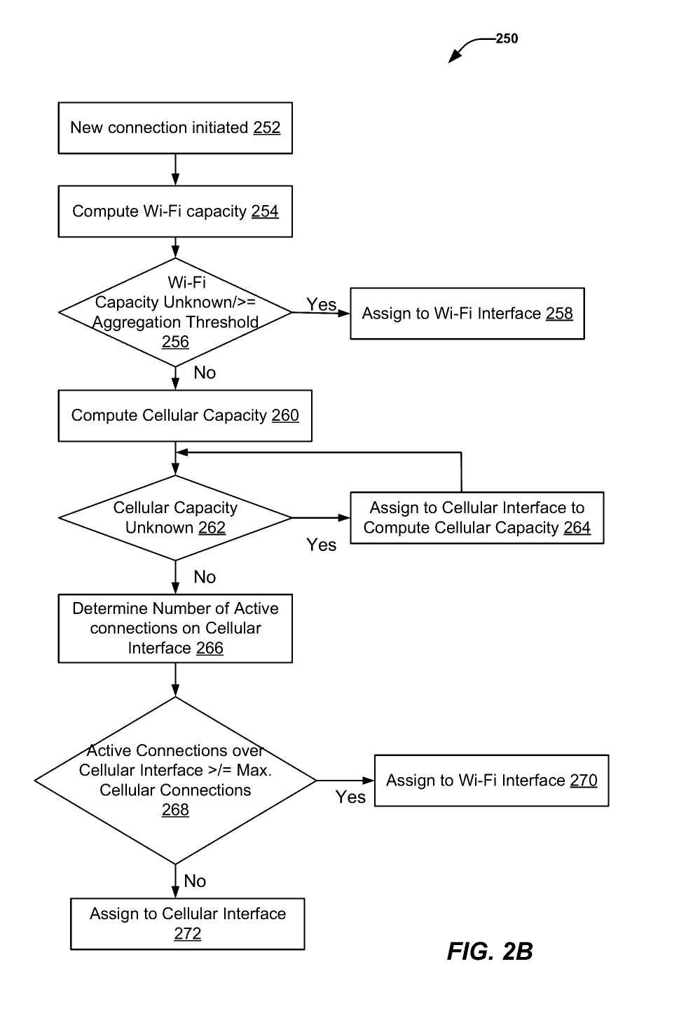

For example, UE 102 may include a UE performance management 106 configured to monitor the data rate on Wi-Fi interface 124. This may be achieved by continuously computing (e.g., calculating, estimating, determining, etc.) capacity estimate (e.g., first capacity estimate 154) over Wi-Fi interface 124. In an aspect, UE 102 and/or UE performance management function 106 may use transport layer information, e.g., monitoring timing of packet arrivals (as described in detail in reference to FIG. 2 below) or by use of interface-specific media access control (MAC) layer statistics, statistics on modulation and coding schemes (MCS) used and MAC packet error rates observed, for monitoring the Wi-Fi interface. Further, UE performance management function 106 may compute the first capacity estimate 154 over Wi-Fi interface 124 and detect that the first capacity is below an aggregation threshold 152. In an aspect, if UE performance management function 106 determines that the first capacity estimate 154 is below the aggregation threshold 152, UE 102 and/or UE performance management function 106 may compute a second capacity estimate 156 over the cellular interface 134 and assign a new connection initiated at 102 to the Wi-Fi interface 124 or the cellular interface 134. The assignment of the connection to the Wi-Fi or the cellular interface may be based on the first and the second capacity estimates.

In an additional aspect, UE 102 and/or UE performance management function 106 may monitor cellular interface 134 as well for computing (e.g., calculating, estimating, determining, etc.) the data rate on cellular interface 134 (e.g., DL 138) to avoid overloading the cellular interface and/or to manage performance of the UE. That is, UE 102 and/or UE performance management function 106 may monitor cellular interface 134 to assist in determining the number of TCP connections that may be assigned to cellular interface 134. In other words, when to assign TCP connections to the cellular interface and when to stop assigning TCP connections to the cellular interface.

In an aspect, network entities 120 and/or 130 may include, but not limited to, an access point, a base station (BS) or Node B or eNodeB, a macro cell, a small cell (e.g., a femtocell, or a picocell), a relay, a peer-to-peer device, an authentication, authorization and accounting (AAA) server, a mobile switching center (MSC), Mobility Management Entity (MME), SON management server, OAM server, Home NodeB Management System (HMS), Home eNodeB Management System (HeMS), etc. Additionally, network entities 120 and/or 130 may include one or more of any type of network components that can enable AP 122 and/or cellular base station 132 communicate and/or establish and maintain links 126, 128, 136, and/or 138 with UE 102. In an example aspect, AP 122 may operate according to wireless local area network (WLAN) specification as defined in IEEE 802.11 and/or cellular base station 132 may operate according to Wideband Code Division Multiple Access (W-CDMA), Code Division Multiple Access (CDMA), Time Division Synchronous Code Division Multiple Access (TD-SCDMA), Long Term Evolution (LTE), or Global System for Mobile Communications (GSM) standard as defined in 3GPP Specifications.

In an additional aspect, UE 102 may be a mobile apparatus and may also referred to by those skilled in the art as a mobile station, a subscriber station, a mobile unit, a subscriber unit, a wireless unit, a remote unit, a mobile device, a wireless a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, UE performance management function 106 may also be configured to transmit/receive messages to/from network entities 120, 130 via one or more radio frequency (RF) transceiver(s) 116. For example, UE performance management function 106 may include and execute communication protocols and/or manage other standards-specific communication procedures using protocol- and/or standards-specific instructions and/or subscription-specific configuration information that allow communications with the network entities 120, 130 and UE 102. Further, RF transceiver 116 may be configured to transmit and/or receive the communication exchange signaling to and/or from one or more APs 122 and/or cellular base stations 132 or other devices in wireless communication system 100. For example, RF transceiver 116 may include, but is not limited to, one or more of a transmitter, a receiver, a transceiver, protocol stacks, transmit chain components, and/or receive chain components. Additionally, UE 102 may include memory 118 coupled to processor 104 for managing performance of the UE.

In an aspect, UE 102 may include a UE performance management function 106 for managing performance of a UE by computing, at a user equipment (UE), a first capacity estimate over a Wi-Fi interface in response to initiating of a new connection at the UE; detecting, at the UE, that the first capacity estimate is below an aggregation threshold; computing, at the UE, a second capacity estimate over a cellular interface in response to detecting that the first capacity estimate is below the aggregation threshold; and assigning the new connection initiated at the UE to the Wi-Fi interface or the cellular interface based at least on the first capacity estimate or the second capacity estimate.

Further, as described herein, for example, network entities 120 and/or 130 may include, but not limited to, an access point, a base station (BS) or Node B or eNodeB, a macro cell, a small cell (e.g., a femtocell, or a picocell), a relay, a peer-to-peer-to-peer device, an authentication, authorization and accounting (AAA) server, a mobile switching center (MSC), Mobility Management Entity (MME), SON management server, OAM server, Home NodeB Management System (HMS), Home eNodeB Management System (HeMS), etc. Additionally, network entities 120 and/or 130 may include one or more of any type of network components that can enable APs 122 and/or base stations 132 communicate and/or establish and maintain links with 102.

Also, as described herein, for example, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

FIG. 2A is a block diagram illustrating an example aspect for managing performance of a user equipment running a browsing application, in accordance with aspects of the present disclosure.

For instance, FIG. 2A illustrates UE 102 running a browsing application 202 to access Internet 214 via hypertext transfer protocol secure (HTTPS) 204. In an aspect, for example, UE 102 may include UE performance management function 106 for managing performance of the UE when accessing Internet 214 via AP 122 and/or BS 132. For example, UE performance management function 106 may detect that first capacity estimate 154 is below aggregation threshold 152 and may compute second capacity estimate 156. UE performance management function 106 may assign one or more new connections initiated at UE 102 to cellular interface 134 based at least on the second capacity estimate. Additionally, in an aspect, UE 102 and/or UE performance management function 106 may respectively communicate with AP 122 and BS 132 using WLAN stack 206 and WWAN stack 208 over Wi-Fi interface 124 and cellular interface 134, respectively. That is, UE 102 and/or UE performance management function 106 accesses Wi-Fi interface 124 via WLAN stack 206 and accesses cellular interface 134 via WWAN stack 208. Additional details of managing performance of the UE over Wi-Fi and cellular interfaces is described below in detail in reference to FIG. 2B.

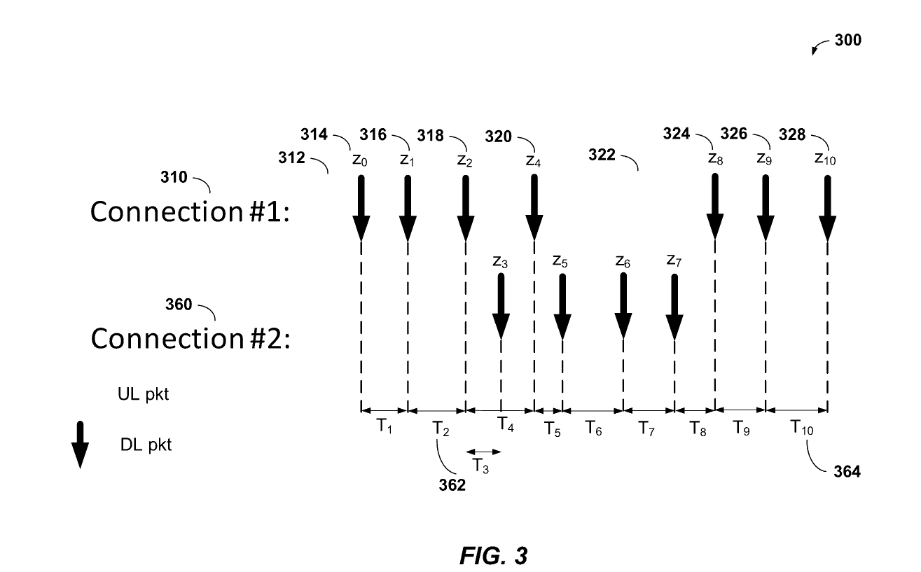

FIG. 2B is a flow chart illustrating an example aspect for managing performance of a user equipment, in accordance with aspects of the present disclosure. At operation 252, a new connection may be initiated at UE 102. For instance, a new connection may be initiated at UE 102 by the user of UE 102 a browsing application 202 and using an uniform resource locator (URL) address to access a resource on Internet 214. That is, the user of UE 102 launches a browsing application 202 for downloading data which may initiate one or more connections TCP sockets) for communication between the UE and a website with the URL. At operation 254, UE 102 and/or UE performance management function 106 may compute capacity of Wi-Fi interface 124 (e.g., first capacity estimate 154). In an aspect, first capacity estimate 154 may be computed using the approach described below in reference to FIG. 3. For instance, the capacity estimate of Wi-Fi interface may be estimated by average amount of data received over a period of time or available for data transfers.

At operation 256, UE 102 and/or UE performance management function 106 may determine whether Wi-Fi capacity (e.g., first capacity estimate 154) is unknown or greater than or equal to aggregation threshold 152. In an aspect, if Wi-Fi capacity (e.g., first capacity estimate 154) is unknown or if the Wi-Fi capacity is greater than the aggregation threshold, UE 102 and/or UE performance management function 106 assigns the new connection to Wi-Fi interface 124 at operation 258.

At operation 260, UE 102 and/or UE performance management function 106 may compute capacity of cellular interface 134 (e.g., second capacity estimate 156) if UE 102 and/or UE performance management function 106 determines that first capacity estimate 154 is known and below aggregation threshold 152. At operation 262, UE 102 and/or UE performance management function 106 determines whether capacity of cellular interface 134 (e.g., second capacity estimate 156) is unknown. If UE 102 and/or UE performance management function 106 determines that second capacity estimate 156 is unknown, at operation 264, UE 102 and/or UE performance management function 106 may gradually assign new connections to cellular interface 134 for computing second capacity estimate 156. That is, new connections may be assigned to cellular interface 134 gradually (e.g., one at a time) based on a “cellular connection assign rate.” For example, cellular connection assign rate may be defined as the rate at which new connections may be assigned to cellular interface 134 At operation 266, UE 102 and/or UE performance management function 106 determines the number of active connections on cellular interface 134. At operation 268, UE 102 and/or UE performance management function 106 may determine whether the number of active cellular connections in cellular interface 134 greater than or equal to a maximum number of active connections allowed on cellular interface 134. If UE 102 and/or UE performance management function 106 that the number of active connections over cellular interface 134 is greater than or to the maximum number of active connections allowed over cellular interface 134, a new connection is assigned to Wi-Fi interface 124. Alternatively, at operation 272, new connection is assigned to cellular interface 134. The procedure described above may be used to determine whether to assign a connection (e.g., a new connection) to Wi-Fi or the cellular interface so that the performance of the UE can be managed.

In an aspect, for example, a ratio of number of active connections on Wi-Fi interface 124 over a maximum number of active connections over cellular interface 134 may be calculated as a ratio of first capacity estimate 154 and a difference between aggregation threshold 152 and first capacity estimate 154. In an additional aspect, for example, a ratio of number of active connections on Wi-Fi interface 124 over a maximum number of active connections over cellular interface 134 may be calculated as a ratio of first capacity estimate 154 and the minimum of difference between aggregation threshold 152 and first capacity estimate 154, and second capacity estimate 156.

FIG. 3 illustrates an example aspect for computing (e.g., estimating) capacity estimates over Wi-Fi interface 124 and/or cellular interface 134 at UE 102, in accordance with aspects of the present disclosure. As used herein, a “connection” is a TCP socket for data transfer (e.g., reception). In particular, according to a first feature of the present aspects, the computed or estimated capacity estimates, e.g., the capacity estimate of Wi-Fi interface 124 may be used initially to determine whether or not to utilize cellular interface 134 to supplement Wi-Fi interface 124 to increase the data rate available to UE 102. Additionally, according to a second feature of the present aspects, whether or not the Wi-Fi or cellular data rate is known, and its respective value and the threshold value, may be utilized in order to distribute new connections between Wi-Fi interface 124 and cellular interface 134 as is described in more detail below.

In an example aspect, UE 102 and/or UE performance management function 106 may use a tuple (e.g., source port, destination address, destination port, etc.) to identify each connection. The algorithm can keep track of connections that sent or received a packet in the last “T_inactive” seconds. This information may be needed by the algorithm to determine how many connections to send on Wi-Fi vs. Cellular.

For instance, in FIG. 3, an example is illustrated with two connections (e.g., connection #1 310 and connection #2 360) for computing capacity estimates over an interface at UE 102. The connections may be on Wi-Fi interface 124 or cellular interface 134. For instance, capacity estimates over an interface may be computed by averaging the amount of data transferred, for example, an amount of data downloaded at the UE over DL 128 (for Wi-Fi interface 124) or DL 138 (for cellular interface 134) over a given period of time. Although, data rates may be computed on uplink (UL) as well, the present disclosure describes the procedure in the context of downloading data at the UE 102. Additionally, the data rates are computed on a per interface basis (e.g., Wi-Fi interface 124, cellular interface 134) and the connection level information is generally used to determine if a DL packet was preceded by an UL packet belonging to the same connection.

In an aspect, when DL data rates over an interface are computed at UE 102, the first DL packet after an UL packet is not considered (e.g., ignored) for DL data rate computation purposes as the first DL data packet (that follows an UL packet) is a reference packet for the DL packets that follow. For instance, for connection #1 310, data packets represented by “Z₀” and “Z₈” that respectively follow UL packets 312 and 322 are considered as reference packets and are not considered in computing DL data rate at the UE. Similarly, for connection #2 360, data packet represented by “Z₃” is considered as a reference packet and is not considered in computing DL data rate at the UE.

For instance, in aspect, the data rate at the UE over an interface may be computed or estimated using the formula: data rate=(ΣZ)/(ΣT), where each Z represents a packet size of a packet sent/received at a time Z. For example, in an aspect, the data rate at the end of time period “T2” 262 may be computed using the following: (Z1+Z2)/(T1+T2). In additional aspect, for example, data rate at the end of time period “T10” 264 may be computed using the following:

(Z₁+Z₂+Z₄+Z₅+Z₆+Z₇+Z₉+Z₁₀)/(T1+T2+T4+T5+T6+T7+T9+T10)

In an aspect, UE 102 and/or UE performance management function 106 may use the procedure described above for computing data rates over DL 128 (of Wi-Fi interface 124) and/or DL 138 (of cellular interface 134).

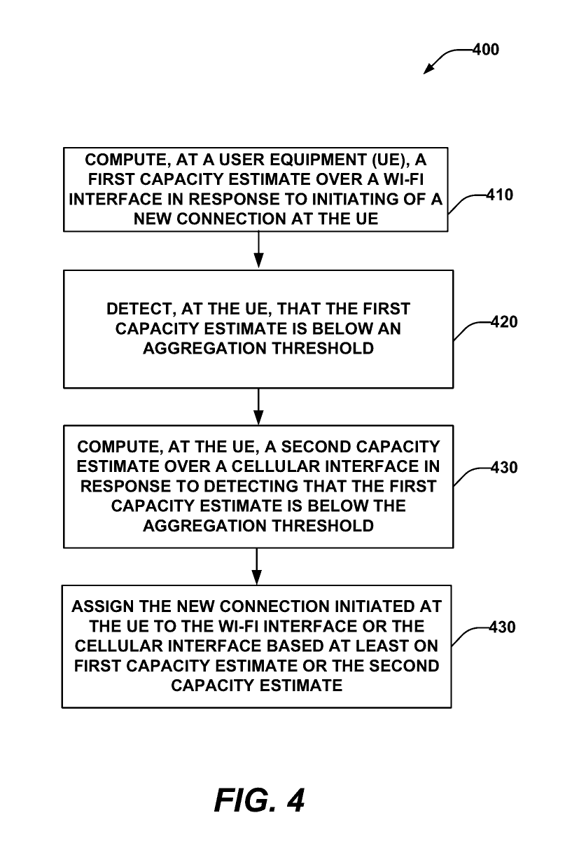

FIG. 4 illustrates a flowchart of a method 400 for managing performance of a user equipment (UE).

In an aspect, at block 410, methodology 400 may include computing, at a user equipment (UE), a first capacity estimate over a Wi-Fi interface in response to initiating of a new connection at the UE. For example, in an aspect, UE 102 and/or UE performance management function 106 may include a Wi-Fi interface function 108, such as a specially programmed processor module, or a processor executing specially programmed code stored in a memory to compute a first capacity estimate 154 over Wi-Fi interface 124 in response to initiating of a new connection at the UE. That is, Wi-Fi interface function 108 computes available capacity over Wi-Fi interface 124 when a new connection is initiated at the UE.

For instance, first capacity estimate 154 over Wi-Fi interface 124 may be computed, for example, as described above in detail in reference to FIG. 3. In an aspect, for example, first capacity estimate 154 may be computed based on entries in a circular buffer at the UE (e.g., receive buffer). A minimum number of entries (which may be configurable) may be needed in the buffer to obtain a valid estimate, and entries prior to a certain point in time may be considered stale and may be ignored when computing the first capacity estimate for obtaining a real-time (or close to real-time) estimate. Additionally, in an aspect, when the first capacity estimate 154 is being computed, some packets may be excluded (e.g., a first packet received on a DL which is preceded by an UL packet of the same connection).

In an aspect, at block 420, methodology 400 may include detecting, at the UE, that the first capacity estimate is below an aggregation threshold. For example, in an aspect, UE 102 and/or UE performance management function 106 may include the Wi-Fi interface function 108, such as a specially programmed processor module, or a processor executing specially programmed code stored in a memory, to detect at UE 102 that the first capacity estimate 154 is below an aggregation threshold 152.

For instance, aggregation threshold 152 may be chosen (e.g., defined, configured, etc.) to optimize the performance of UE 102. Aggregation threshold 152 may be defined as a threshold below which UE 102 and/or UE performance management function 106 may use cellular interface 134 to supplement the Wi-Fi interface. In an aspect, aggregation threshold 152 is set such that the impact on UE performance is minimized. For example, if UE 102 and/or UE performance management function 106 sets the aggregation threshold 152 to a low value, the performance of UE 102 may be negatively affected and if the threshold is set to a high value, UE 102 and/or UE performance management function 106 may use the cellular interface 134 unnecessarily for downloading data at UE 102. Additionally, in an aspect, aggregation threshold 152 may be chosen based on the analysis of operation measurements (OMs) data generated at the UE 102, AP 122 and/or BS 132; and/or be set at a UE, an AP/BS, or a network level.

In an aspect, for example, UE 102 and/or UE performance management function 106 may detect that first capacity estimate 154 is below aggregation threshold 152 based on the continuous monitoring of first capacity estimate 154 over Wi-Fi interface at UE 102 and/or whenever a new connection (e.g., TCP connection or socket) is initiated at the UE. Additionally, in an aspect, aggregation threshold 152 may be set or configured at the UE via a user interface. The configuration of aggregation threshold 152 at the UE via an user interface provides the flexibility (e.g., option) to the user of the UE to select the threshold value depending on the user's preferences as the network operator may charge the user for usage of cellular data (or usage of cellular data over a certain limit). That is, user of UE 102 and/or UE performance management function 106 may configure aggregation threshold 152 based on the user's preferences and/or sensitivity to delay in downloading data (e.g., when using the Wi-Fi interface) and/or costs associated with downloading data via cellular interface 134. In an additional or optional aspect, a network operator may set aggregation threshold 152 at a level to maintain uniformity across the network.

In an aspect, at block 430, methodology 400 may include computing, at UE, a second capacity estimate over a cellular interface in response to detecting that first capacity estimate is below the aggregation threshold. For example, in an aspect, UE 102 and/or UE performance management function 106 may include a cellular interface function 110, such as a specially programmed processor module, or a processor executing specially programmed code stored in a memory, to compute at 102 a second capacity estimate 156 over cellular interface 134 in response to that the first capacity estimate 154 is below the aggregation threshold 152.

In an additional or optional aspect, if UE 102 and/or UE performance management function 106 does not have any information on second capacity estimate 156, for example, due to absence of sufficient connections (e.g., sockets such as TCP sockets associated with the data download) assigned to cellular interface 134, UE 102 and/or UE performance management function 106 may gradually (e.g., one or more at a time) assign new connections to cellular interface 134 until the second capacity estimate 156 may be computed. This approach may mitigate the risk associated with blind assignment of new connections to cellular interface 134 where the capacity estimate on the cellular interface is not known and/or the performance of the UE may not improve. Additionally, the second capacity estimate 156 may be computed by averaging amount of data received on the cellular interface 134 over a period of time, e.g., over 10 milliseconds.

In an aspect, at block 440, methodology 400 may include assigning the new connection initiated at the UE to the Wi-Fi interface or the cellular interface based at least on the first capacity estimate or the second capacity estimate. For example, in an aspect, UE 102 and/or UE performance management function 106 may include an assignment function 112, such as a specially programmed processor module, or a processor executing specially programmed code stored in a memory, to assign the new connection initiated at the UE to Wi-Fi interface 124 or cellular interface 134 based at least on first capacity estimate 154 or second capacity estimate 156, or a combination of first capacity estimate 154 and second capacity estimate 156.

For instance, UE 102 and/or UE performance management function 106 may compute the maximum number of active connections allowed over cellular interface 134 based at least on aggregation threshold 152, first capacity estimate 154, and/or second capacity estimate 156. In an additional aspect, UE 102 and/or UE performance management function 106 may compute the number of active on cellular interface 134 and assign the new connection initiated at the UE to cellular interface 134 when the number of active connections over the cellular interface 134 is less than the maximum number of active connections allowed over the cellular interface. In a further additional aspect, for example, UE 102 and/or UE performance management function 106 may compute the number of active connections on the cellular interface and assign the new connection initiated at the UE to the Wi-Fi interface when the number of active connections over the cellular interface is equal to or more than a maximum number of active connections allowed over the cellular interface.

In an additional or optional aspect when UE 102 and/or UE performance management function 106 detects that data rate over Wi-Fi interface 124 is equal to or above the threshold, UE performance management function 106 may execute assignment function 112 to assign the new connections to the Wi-Fi interface at least until UE detects that the data rate over the Wi-Fi interface is below the threshold. For instance, UE 102 and/or UE performance management function 106 may execute assignment function 112 to start assigning connections to the Wi-Fi interface if the data rate over the Wi-Fi is not below the first threshold based on the continuous monitoring and comparing of the data rate over the Wi-Fi interface.

As such, performance of a UE may be managed by assigning at least some new connections initiated at the UE to the cellular interface when the data rate over a Wi-Fi interface is below a threshold.

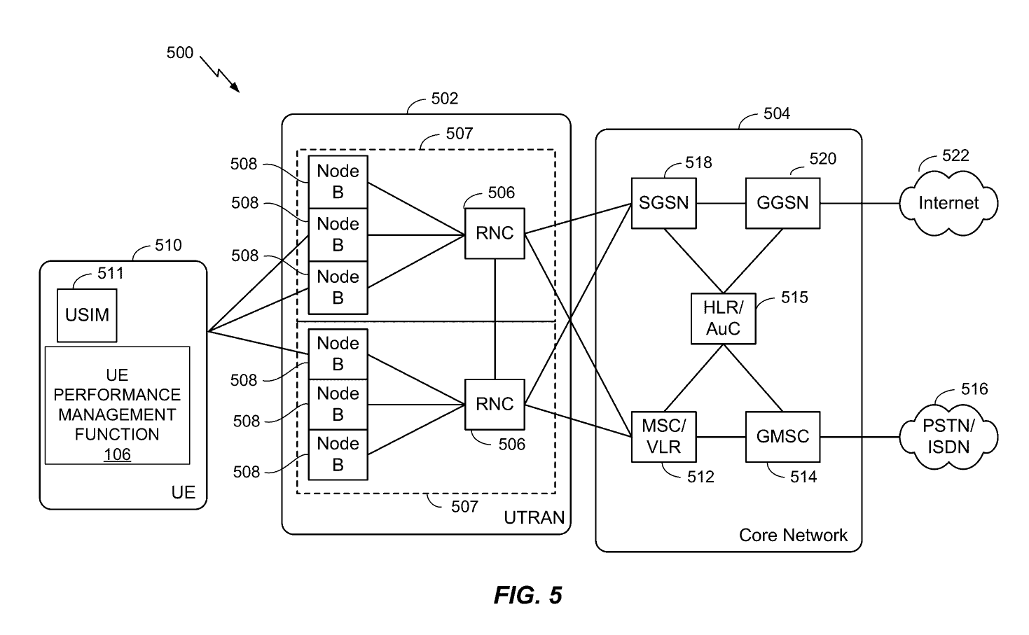

FIG. 5 is a block diagram conceptually illustrating an example of a telecommunications system, including aspects of the system of FIG. 1. By way of example and without limitation, the aspects of the present disclosure illustrated in Fig. are presented with reference to a UMTS system 500 employing a W-CDMA air interface and may include UE 102 executing an aspect of UE performance function 106 (FIG. 1). The networks described above that include a UE 102 having a UE performance management function 106 may be part of or may be associated with system such as UMTS system 500. A UMTS network includes three interacting domains: a Core Network (CN) 504, a UMTS Terrestrial Radio Access Network (UTRAN) 502 which may include NodeB 508 (which may be an example of base station 132 and/or AP 122) and User Equipment (UE) 510 (which may be an example of UE 102 of FIG. 1). In this example, the UTRAN 502 provides various wireless services including telephony, video, data, messaging, broadcasts, and/or other The UTRAN 502 may include a plurality of Radio Network Subsystems (RNSs) such as an RNS 507, each controlled by a respective Radio Network Controller (RNC) as an RNC 506. Here, the UTRAN 502 may include any number of RNCs 506 and RNSs 507 in addition to the RNCs 506 and RNSs 507 illustrated herein. The RNC is an apparatus responsible for, among other things, assigning, reconfiguring and releasing radio resources within the RNS 507. The RNC 506 may be interconnected other RNCs (not shown) in the UTRAN 502 through various types of interfaces such a direct physical connection, a virtual network, or the like, using any suitable transport network.

Communication between a UE 510 and a NodeB 508 may be considered as including a physical (PHY) layer and a medium access control (MAC) layer. Further, communication between a UE 510 and an RNC 506 by way of a respective NodeB 508 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in Radio Resource Control (RRC) Protocol Specification, 3GPP TS 25.331 v9.1.0, incorporated herein by reference.

The geographic region covered by the SRNS 507 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point or some other suitable terminology. For clarity, three NodeBs 508 are shown in each SRNS 507; however, the SRNSs 507 may include any number of wireless NodeBs. The NodeBs 508 provide wireless access points to a core network (CN) 504 for any number of mobile apparatuses. Examples of a mobile apparatus include a cellular phone, a smart phone, a session initiation protocol (SIP) phone, a laptop, a notebook, netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile a wireless terminal, a remote terminal, a handset, a terminal, a user agent, a mobile client, a client, or some other suitable terminology. In a UMTS system, the UE 510 may further include a universal subscriber identity module (USIM) 511, which a user's subscription information to a network. For illustrative purposes, one UE 510 shown in communication with a number of the NodeBs 508. The downlink (DL), also called the forward link, refers to the communication link from a NodeB 508 to a UE 510, and the uplink (UL), also called the reverse link, refers to the communication from a UE 510 to a NodeB 508.

The core network 504 interfaces with one or more access networks, such as the UTRAN 502. As shown, the core network 504 is a GSM core network. However, as those skilled in the art will recognize, the various concepts presented throughout this disclosure may be implemented in a RAN, or other suitable access network, to provide UEs with access to types of core networks other than GSM networks. The core network 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and Gateway GPRS Support Node (GGSN). Some network elements, like EIR, HLR, and AuC may be shared by both of the circuit-switched and packet-switched domains. In the illustrated example, the core network 504 supports circuit-switched services a MSC 512 and a GMSC 514. In some applications, the GMSC 514 may be referred as a media gateway (MGW). One or more RNCs, such as the RNC 506, may be connected to the MSC 512. The MSC 512 is an apparatus that controls call setup, call routing, and UE mobility functions. The MSC 512 also includes a visitor location register (VLR) that contains subscriber-related information for the duration that a UE in the coverage area of the MSC 512. The GMSC 514 provides a gateway through MSC 512 for the UE to access a circuit-switched network 516. The core network 504 includes a home location register (HLR) 515 containing subscriber data, such as the data reflecting the details of the services to which a particular user has subscribed. HLR is also associated with an authentication center (AuC) that contains subscriber-subscriber-specific authentication data. When a call is received for a particular UE, GMSC 514 queries the HLR 515 to determine the UE's location and forwards the call to the particular MSC serving that location.

The core network 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a NodeB 508 and a UE 510. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

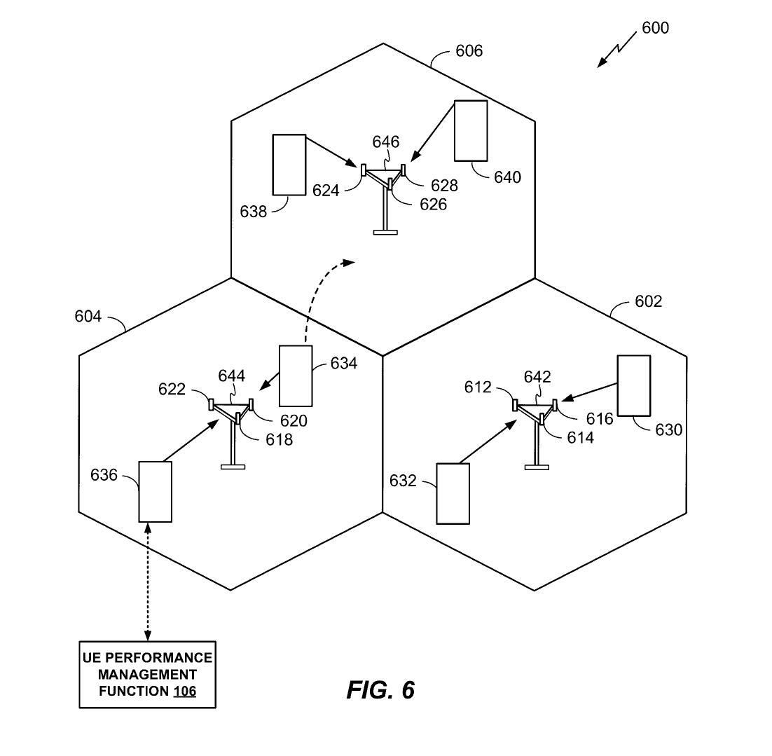

Referring to FIG. 6, an access network 600 in UTRAN architecture is illustrated, and may include UEs 630, 632, 634, 636, 638, and/or 640, which may be same as or similar to UE 102 (FIG. 1) in that it is configured to include UE management function 106 (FIG. 6; for example, illustrated here as being associated UE 636 for managing performance) and/or cells 602, 604, and 606, which be the same as or similar to BS 132 and/or AP 122 (FIG. 1). The multiple sectors can be formed groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604, and 606 may include wireless communication devices, e.g., User Equipment or UEs, which may be in communication with one or more sectors of each cell 602, 604, or 606. For example, UEs 630 and 632 may be in communication with NodeB 642, UEs 634 and 636 may in communication with NodeB 644, and UEs 638 and 640 can be in communication with NodeB 646. Here, each NodeB 642, 644, and 646 is configured to provide an access point to a CN 504 (see FIG. 5) for all the UEs 630, 632, 634, 636, 638, and 640 the respective cells 602, 604, and 606. UEs 630, 632, 634, 636, 638, and 640 may be similar to UE 102 described above, and NodeBs 642, 644, and/or 646 can correspond AP 122 and/or base station 132 described in, for example, FIG. 1.

As the UE 634 moves from the illustrated location in cell 604 into cell 606, a serving cell change (SCC) or handover may occur in which communication with the UE 634 transitions from the cell 604, which may be referred to as the source cell to cell 606, which may be referred to as the target cell. Management of the handover procedure may take place at the UE 634, at the NodeBs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel (DPCH) or fractional downlink dedicated physical channel (F-DPCH) to the UE 634 may constitute the Active Set).

The modulation and multiple access scheme employed by the access network 600 may vary depending on the particular telecommunications standard deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. actual wireless communication standard and the multiple access technology employed will depend on the specific application and the overall design constraints imposed on the system.

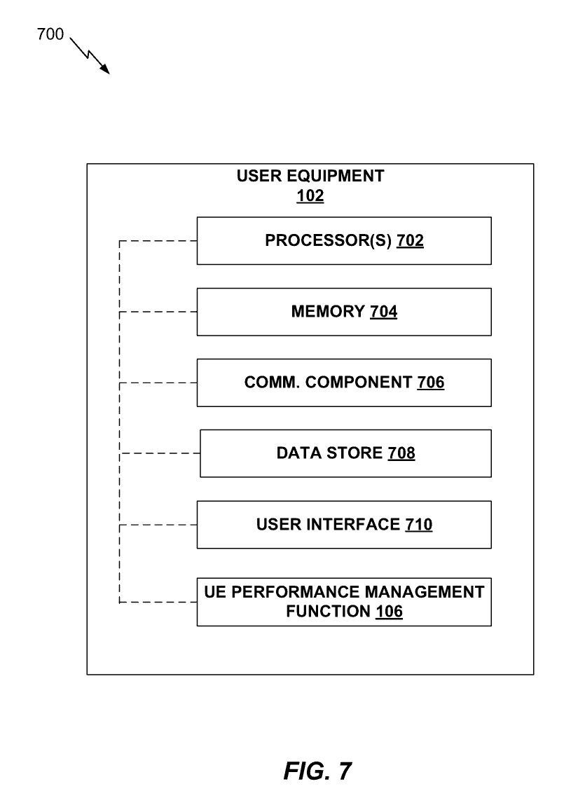

Referring to FIG. 7, in an aspect, user equipment (UE) 102, for example, including UE performance management function 106, may be or may include a specially programmed or configured computer device to perform the functions described herein. In one aspect of implementation, UE 102 and/or UE performance management function 106 may include one or more of the following components: Wi-Fi interface function 108, cellular interface function 110, assignment function 112, RF transceiver 116, memory 118, and/or processor 104 for managing performance at the UE.

In an aspect, for example as represented by the dashed lines, UE performance management function 106 may be implemented in or executed using one or any combination of processor 702 (same or similar to processor 104), memory 704 (same or similar to memory 118), communications component 706, and data store For example, UE performance management function 106 may be executed on one or more processors 702. Further, for example, UE performance management function may be defined as a computer-readable medium stored in memory 704 and/or data 708 and executed by processor 702. Moreover, for example, inputs and outputs to operations of UE performance management function 106 may be provided or supported by communications component 706, which may provide a bus between the components of computer device 700 or an interface for communication with external devices or components.

User equipment 102 may include processor 702 specially configured to carry out processing functions associated with one or more of components and functions described herein. Processor 702 can include a single or multiple set of processors or multi-core processors. Moreover, processor 702 can be implemented as an integrated processing system and/or a distributed processing system.

User equipment 102 further includes memory 704, such as for storing data used herein and/or local versions of applications and/or instructions or code being executed by processor 702, such as to perform the respective functions of the respective entities described herein. Memory 704 can include any type of memory usable by a computer, such as random access memory (RAM), read only memory (ROM), tapes, magnetic discs, optical discs, volatile memory, non-volatile memory, and any combination thereof.

Further, user equipment (UE) 102 includes communications component 706 that provides for establishing and maintaining communications with one or more parties utilizing hardware, software, and services as described herein. Communications component 706 may carry communications between components on user equipment 102, as well as between user and external devices, such as devices located across a communications network and/or devices serially or locally connected to user equipment 102. For example, communications component 706 may include one or more buses, and may further include transmit chain components and receive chain components associated with a transmitter and receiver, respectively, or a transceiver, operable for interfacing with external devices.

Additionally, user equipment 102 may further include data store 708, which can be any suitable combination of hardware and/or software, that provides for mass storage of information, databases, and programs employed in connection with aspects described herein. For example, data store 708 may be a data repository for applications not currently being executed by processor 702.

User equipment 102 may additionally include a user interface component 710 operable to receive inputs from a user of user equipment 102, and further to generate outputs for presentation to the user. User interface component 710 may include one or more input devices, including but not limited to a keyboard, a number pad, a mouse, a touch-sensitive display, a navigation key, a function key, a a voice recognition component, any other mechanism capable of receiving an input from a user, or any combination thereof. Further, user interface component 710 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

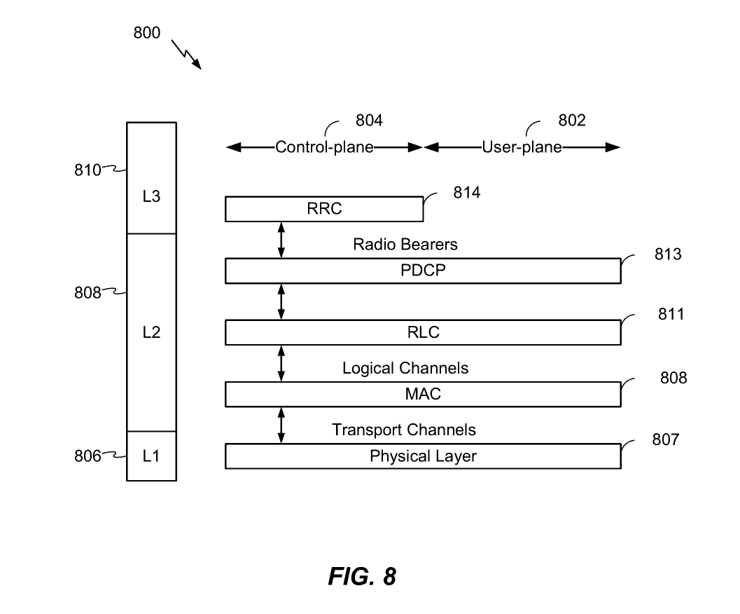

FIG. 8 is a conceptual diagram illustrating an example of the radio protocol architecture 800 for the user plane 802 and the control plane 804 of a user equipment (UE) or a base station. The architecture 800 may be used with the networks described herein that include user equipment 102 having an aspect of UE performance management function 106. For example, architecture 800 may be included in a user equipment 102, network entity 120, access point 122, network entity 130, and/or base station 132, such as the ones described in FIGS. 1, and 5-8. The radio protocol architecture 800 for the user equipment and base station is shown with three layers: Layer 1 806, Layer 2 808, and Layer 3 810. Layer 1 806 is the lowest lower and implements various physical layer signal processing functions. As such, Layer 1 806 includes the physical layer 807. Layer 2 (L2 layer) 808 is above the physical layer 807 and is responsible for the link between the AP and UE over the physical layer 807. Layer 3 (L3 layer) 810 includes a radio resource control (RRC) sublayer 814. The RRC sublayer 814 handles the control plane signaling of Layer 3 between the UE and the UTRAN.

In the user plane, the L2 layer 808 includes a media access control (MAC) sublayer 808, a radio link control (RLC) sublayer 811, and a packet data convergence protocol (PDCP) 813 sublayer, which are terminated at the AP on the network side. Although not shown, the UE may have several upper layers above the L2 layer 808 including a network layer (e.g., IP layer) that is terminated at a PDN gateway on the network side, and an application layer that is terminated at the other end of the connection (e.g., far end UE, server, etc.).

The PDCP sublayer 813 provides multiplexing between different radio bearers and logical channels. The PDCP sublayer 813 also provides header compression for upper layer data packets to reduce radio transmission overhead, security by ciphering the data packets, and handover support for UEs between The RLC sublayer 811 provides segmentation and reassembly of upper layer data packets, retransmission of lost data packets, and reordering of data packets to compensate for out-of-order reception due to hybrid automatic repeat request The MAC sublayer 808 provides multiplexing between logical and transport channels. The MAC sublayer 808 is also responsible for allocating the various radio resources (e.g., resource blocks) in one cell among the UEs. The MAC sublayer 808 is also responsible for HARQ operations.

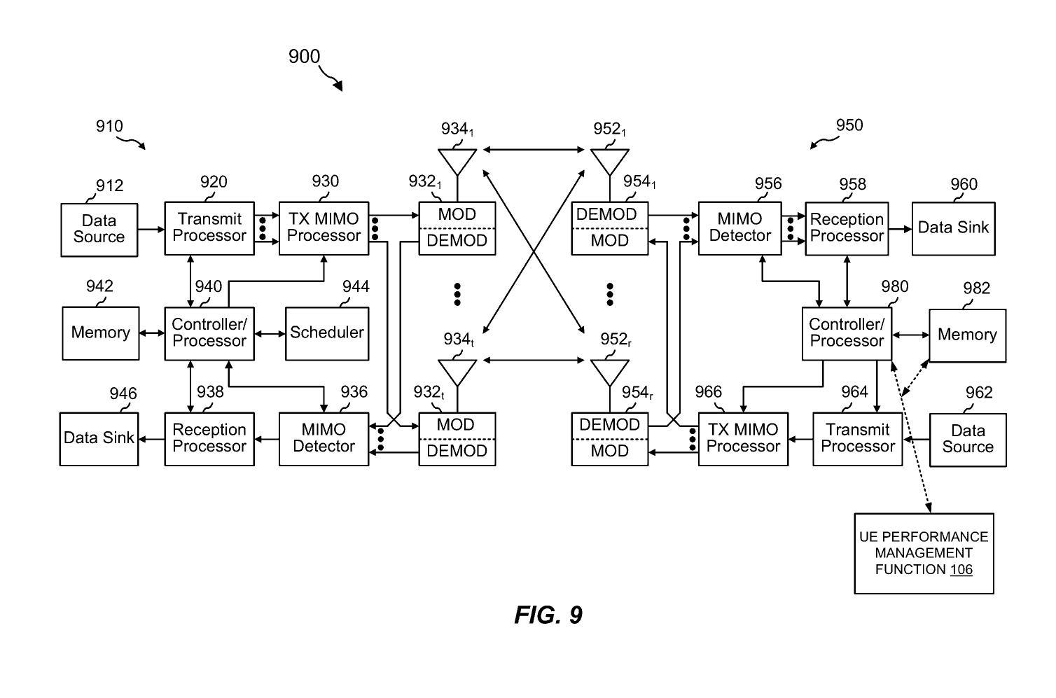

FIG. 9 is a block diagram 900 conceptually illustrating examples of a user equipment (UE) 950 and an eNodeB 910 configured in accordance with an aspect of the present disclosure, wherein the user equipment may be configured to include an instance of UE performance management function 106. For example, UE 950 and base station/eNodeB/AP 910 of a system 900, as shown in FIG. 9, may be the UE and the base station in FIGS. 1, 5-7, and 9. The base station 910 may be equipped with antennas 9341-t, and the UE 950 may be equipped with antennas 9521-r, wherein t and r are integers greater than or equal to one.

At the base station 910, a base station transmit processor 920 may receive data from a base station data source 912 and control information from a base station controller/processor 940. The control information may be carried on the PBCH, PCFICH, PHICH, PDCCH, etc. The data may be carried on the PDSCH, etc. The station transmit processor 920 may process (e.g., encode and symbol map) the data control information to obtain data symbols and control symbols, respectively. The station transmit processor 920 may also generate reference symbols, e.g., for the PSS, SSS, and cell-specific reference signal (RS). A base station transmit (TX) multiple-multiple-input multiple-output (MIMO) processor 930 may perform spatial processing (e.g., precoding) on the data symbols, the control symbols, and/or the reference symbols, if applicable, and may provide output symbol streams to the base station modulators/demodulators (MODs/DEMODs) 9321-t. Each base station modulator/demodulator 932 may process a respective output symbol stream (e.g., for OFDM, etc.) to obtain an output sample stream. Each base station modulator/demodulator 932 may further process (e.g., convert to analog, amplify, filter, and upconvert) the output sample stream to obtain a downlink signal. signals from modulators/demodulators 9321-t may be transmitted via the antennas 9341-t, respectively.

At the UE 950, the UE antennas 9521-r may receive the downlink signals from the base station 910 and may provide received signals to the UE modulators/demodulators (MODs/DEMODs) 9541-r, respectively. Each UE modulator/demodulator 954 may condition (e.g., filter, amplify, downconvert, and digitize) a respective received signal to obtain input samples. Each UE modulator/demodulator 954 may further process the input samples (e.g., for OFDM, etc.) to obtain received symbols. A UE MIMO detector 956 may obtain received symbols from all the UE modulators/demodulators 9541-r and perform MIMO detection on the received symbols if applicable, and provide detected symbols. A UE reception processor 958 may process (e.g., demodulate, deinterleave, and decode) the detected symbols, provide decoded data for the UE 950 to a UE data sink 960, and provide decoded control information to a UE controller/processor 980.

On the uplink, at the UE 950, a UE transmit processor 964 may receive and process data (e.g., for the PUSCH) from a UE data source 962 and control information (e.g., for the PUCCH) from the UE controller/processor 980. The UE transmit processor 964 may also generate reference symbols for a reference signal. The symbols from the UE transmit processor 964 may be precoded by a UE TX MIMO processor 966 if applicable, further processed by the UE modulator/demodulators 9541-r (e.g., for SC-FDM, etc.), and transmitted to the base station 910. At the base station 910, the uplink signals from the UE 950 may be received by the base station antennas 934, processed by the base station modulators/demodulators 932, detected by a base station MIMO detector 936 if applicable, and further processed by a base station reception processor 938 to obtain decoded data and control information sent by the UE 950. The base station reception processor 938 may provide the decoded data to a base station data sink 946 and the decoded control information to the base station controller/processor 940.

The base station controller/processor 940 and the UE controller/processor 980 may direct the operation at the base station 910 and the UE 950, respectively. base station controller/processor 940 and/or other processors and modules at the base station 910 may perform or direct, e.g., various processes for the techniques described herein (e.g., as illustrated in FIGS. 1-9). The base station memory 942 and the UE memory 982 may store data and program codes for the base station 910 and the UE respectively. A scheduler 944 may be used to schedule UE 950 for data transmission on the downlink and/or uplink.

The various concepts presented throughout this disclosure may be implemented across a broad variety of telecommunication systems, network architectures, and communication standards.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm operations described in connection with the disclosure herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The step/operation of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose special purpose computer. By way of example, and not limitation, such computer-computer-readable media can comprise RAM, ROM, EEPROM, CD-ROM or other optical disk storage, magnetic disk storage or other magnetic storage devices, or any other medium that can be used to carry or store desired program code means in the of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber cable, twisted pair, DSL, or wireless technologies such as infrared, radio, and microwave are included in the definition of medium. Disk and disc, as used herein, includes compact disc (CD), laser disc, optical disc, digital versatile disc (DVD), disk and Blu-ray disc where disks usually reproduce data magnetically, while discs reproduce data optically with lasers. Combinations of the above should also be within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for managing performance of a user equipment (UE), comprising:
computing, at a user equipment (UE), a first capacity estimate over a Wi-Fi interface in response to initiating of a new connection at the UE;
detecting, at the UE, that the first capacity estimate is below an aggregation threshold;
computing, at the UE, a second capacity estimate over a cellular interface in response to detecting that the first capacity estimate is below the aggregation threshold; and
assigning the new connection initiated at the UE to the Wi-Fi interface or the cellular interface based at least on the first capacity estimate or the second capacity estimate.

2. The method of claim 1, further comprising:
determining a maximum number of active connections allowed over the cellular interface based at least on a number of active connections on the Wi-Fi interface, the aggregation threshold, and the first capacity estimate.

3. The method of claim 2, wherein the assigning further comprises:
computing a number of active connections on the cellular interface; and
assigning the new connection initiated at the UE to the cellular interface when the number of active connections over the cellular interface is less than the maximum number of active connections allowed over the cellular interface.

4. The method of claim 1, wherein the assigning further comprises:
computing a number of active connections on the cellular interface; and
assigning the new connection initiated at the UE to the Wi-Fi interface when the number of active connections over the cellular interface is equal to or more than the maximum number of active connections allowed over the cellular interface.

5. The method of claim 1, wherein a first downlink (DL) packet following an uplink (UL) packet of a same connection is not taken into consideration for computing the first capacity estimate over the Wi-Fi interface or the second capacity estimate over the cellular interface.

6. The method of claim 1, further comprising:
configuring, at the UE, the aggregation threshold via a user interface.

7. An apparatus for managing performance of a user equipment (UE), comprising a memory configured to store data; and
one or more processors communicatively coupled with the memory, wherein the one or more processors and the memory are configured to:
compute, at a user equipment (UE), a first capacity estimate over a Wi-Fi interface in response to initiating of a new connection at the UE;
detect, at the UE, that the first capacity estimate is below an aggregation threshold;
compute, at the UE, a second capacity estimate over a cellular interface in response to detecting that the first capacity estimate is below the aggregation threshold; and
assign the new connection initiated at the UE to the Wi-Fi interface or the cellular interface based at least on the first capacity estimate or the second capacity estimate.

8. The apparatus of claim 7, wherein the one or more processors and the memory are further configured to:
determine a maximum number of active connections allowed over the cellular interface based at least on a number of active connections on the Wi-Fi interface, the aggregation threshold, and the first capacity estimate.

9. The apparatus of claim 8, wherein the one or more processors and the memory are further configured to:
compute a number of active connections on the cellular interface; and
assign the new connection initiated at the UE to the cellular interface when the number of active connections over the cellular interface is less than the maximum number of active connections allowed over the cellular interface.

10. The apparatus of claim 7, wherein the one or more processors and the memory are further configured to:
compute a number of active connections on the cellular interface; and
assign the new connection initiated at the UE to the Wi-Fi interface when the number of active connections over the cellular interface is equal to or more than the maximum number of active connections allowed over the cellular interface.

11. The apparatus of claim 7, wherein a first downlink (DL) packet following an uplink (UL) packet of a same connection is not taken into consideration for computing the first capacity estimate over the Wi-Fi interface or the second capacity estimate over the cellular interface.

12. The apparatus of claim 7, wherein the one or more processors and the memory are further configured to:
configure, at the UE, the aggregation threshold via a user interface.

13. An apparatus for managing performance of a user equipment (UE), comprising means for computing, at a user equipment (UE), a first capacity estimate over a Wi-Fi interface in response to initiating of a new connection at the UE;
means for detecting, at the UE, that the first capacity estimate is below an aggregation threshold;
means for computing, at the UE, a second capacity estimate over a cellular interface in response to detecting that the first capacity estimate is below the aggregation threshold; and
means for assigning the new connection initiated at the UE to the Wi-Fi interface or the cellular interface based at least on the first capacity estimate or the second capacity estimate.

14. The apparatus of claim 13, further comprising:
means for determining a maximum number of active connections allowed over the cellular interface based at least on a number of active connections on the Wi-Fi interface, the aggregation threshold, and the first capacity estimate.

15. The apparatus of claim 14, wherein the assigning further comprises:
means for computing a number of active connections on the cellular interface; and
means for assigning the new connection initiated at the UE to the cellular interface when the number of active connections over the cellular interface is less than the maximum number of active connections allowed over the cellular interface.

16. The apparatus of claim 13, wherein the assigning further comprises:
means for computing a number of active connections on the cellular interface; and
means for assigning the new connection initiated at the UE to the Wi-Fi interface when the number of active connections over the cellular interface is equal to or more than the maximum number of active connections allowed over the cellular interface.

17. The apparatus of claim 13, wherein a first downlink (DL) packet following an uplink (UL) packet of a same connection is not taken into consideration for computing the first capacity estimate over the Wi-Fi interface or the second capacity estimate over the cellular interface.

18. The apparatus of claim 13, further comprising:
means for configuring, at the UE, the aggregation threshold via a user interface.

19. A computer readable medium storing computer executable code for managing performance of a user equipment (UE), comprising:
code for computing, at a user equipment (UE), a first capacity estimate over a Wi-Fi interface in response to initiating of a new connection at the UE;
code for detecting, at the UE, that the first capacity estimate is below an aggregation threshold;
code for computing, at the UE, a second capacity estimate over a cellular interface in response to detecting that the first capacity estimate is below the aggregation threshold; and
code for assigning the new connection initiated at the UE to the Wi-Fi interface or the cellular interface based at least on the first capacity estimate or the second capacity estimate.

20. The computer readable medium of claim 19, further comprising:
code for determining a maximum number of active connections allowed over the cellular interface based at least on a number of active connections on the Wi-Fi interface, the aggregation threshold, and the first capacity estimate.

21. The computer readable medium of claim 20, wherein the assigning further comprises:
code for computing a number of active connections on the cellular interface; and
code for assigning the new connection initiated at the UE to the cellular interface when the number of active connections over the cellular interface is less than the maximum number of active connections allowed over the cellular interface.

22. The computer readable medium of claim 19, wherein the assigning further comprises:
code for computing a number of active connections on the cellular interface; and
code for assigning the new connection initiated at the UE to the Wi-Fi interface when the number of active connections over the cellular interface is equal to or more than the maximum number of active connections allowed over the cellular interface.

23. The computer readable medium of claim 19, wherein a first downlink (DL) packet following an uplink (UL) packet of a same connection is not taken into consideration for computing the first capacity estimate over the Wi-Fi interface or the second capacity estimate over the cellular interface.

24. The computer readable medium of claim 19, further comprising:
code for configuring, at the UE, the aggregation threshold via a user interface.
